(19) United States
(12) Patent Application Publication
(10) Pub. No.: US 2024/0020310 A1
(43) Pub. Date: Jan. 18, 2024

(54) INFORMATION PROCESSING DEVICE, INFORMATION PROCESSING METHOD AND PROGRAM

(71) Applicant: NEC Corporation, Tokyo (JP)

(72) Inventors: Yuyang Dong, Tokyo (JP); Masafumi Oyamada, Tokyo (JP); Takuma Nozawa, Tokyo (JP); Masafumi Enomoto, Tokyo (JP)

(73) Assignee: NEC Corporation, Tokyo (JP)

(21) Appl. No.: 18/220,600

(22) Filed: Jul. 11, 2023

(30) Foreign Application Priority Data
Jul. 15, 2022 (JP) 2022-113698
Sep. 9, 2022 (JP) 2022-143435

(51) Int. Cl. G06F 16/2457; G06F 16/22; G06F 16/25

(52) U.S. Cl. CPC G06F 16/24578; G06F 16/2237; G06F 16/25

(57) ABSTRACT

An information processing device acquires target data, and converts the target data to an embedded vector indicating a latent feature quantity of the target data. Also, the information processing device searches for data similar to the latent feature quantity of the target data as candidate data, and applies a predetermined process to the candidate data to assign a rank to be combined with the target data, for each of the candidate data. Then, the information processing device outputs a result obtained by combining the target data and the candidate data based on the assigned rank.

### TECHNICAL FIELD

The present disclosure relates to information processing associated with combining data.

### BACKGROUND ART

There are known techniques for integrating various databases (heterogeneous databases) having different attributes. Non-Patent Document 1 discloses a technique for determining whether to combine two tables included in different databases using a technique of supervised machine learning.
Non-Patent Document 1: Javier Flores, et al., “Scalable Data Discovery Using Profiles”

### SUMMARY

However, in the technique described in Non-Patent Document 1, the determination of combination is performed for each of the columns included in the table. Therefore, when performing the determination of combination for large-scale data, there is a problem that the calculation cost is large.

The present disclosure has been made in view of the above-described problem, and an example of the object is to provide an information processing technique capable of combining two tables without requiring a high calculation cost even for large-scale data.

According to an example aspect, there is provided an information processing device comprising:
a data acquisition means configured to acquire target data;
a data conversion means configured to convert the target data to an embedded vector indicating a latent feature quantity of the target data;
a candidate search means configured to search for data similar to the latent feature quantity of the target data as candidate data;
a candidate ranking means configured to apply a predetermined process to the candidate data to assign a rank to be combined with the target data, for each of the candidate data; and
a result output means configured to output a result obtained by combining the target data and the candidate data based on the assigned rank.

According to another example aspect, there is provided an information
processing method comprising:
acquiring target data;
converting the target data to an embedded vector indicating a latent feature quantity of the target data;
searching for data similar to the latent feature quantity of the target data as candidate data;
applying a predetermined process to the candidate data to assign a rank to be combined with the target data, for each of the candidate data; and
outputting a result obtained by combining the target data and the candidate data based on the assigned rank.

According to still another example aspect, there is provided a recording medium recording a program, the program causing a computer to execute processing of:
acquiring target data;
converting the target data to an embedded vector indicating a latent feature quantity of the target data;
searching for data similar to the latent feature quantity of the target data as candidate data;
applying a predetermined process to the candidate data to assign a rank to combine with the target data, for each of the candidate data; and
outputting a result obtained by combining the target data and the candidate data based on the assigned rank.

According to still another example aspect, there is provided an information processing device comprising:
a data acquisition means configured to acquire target data;
a data conversion means configured to convert the target data to an embedded vector by inputting a feature vector extracted from the target data into an embedding model, the embedding model representing a distribution of latent feature quantities in a vector space;
a candidate search means configured to search for search target data to which the embedded vector similar to the embedded vector of the target data is associated, as candidate data, by using a search index associating the search target data with the embedded vector of the search target data;
a candidate ranking means configured to apply a predetermined process to the candidate data to assign a rank to be combined with the target data, for each of the candidate data; and
a result output means configured to output a result obtained by combining the target data and the candidate data, based on the assigned rank.

According to still another example aspect, there is provided an information processing method comprising:
acquiring target data;
converting the target data to an embedded vector by inputting a feature vector extracted from the target data into an embedding model, the embedding model representing a distribution of latent feature quantities in a vector space;
searching for search target data to which the embedded vector similar to the embedded vector of the target data is associated, as candidate data, by using a search index associating the search target data with the embedded vector of the search target data;
applying a predetermined process to the candidate data to assign a rank to be combined with the target data, for each of the candidate data; and
outputting a result obtained by combining the target data and the candidate data, based on the assigned rank.

According to still another example aspect, there is provided a recording medium recording a program, the program causing a computer to execute processing of:
acquiring target data;
converting the target data to an embedded vector by inputting a feature vector extracted from the target data into an embedding model, the embedding model representing a distribution of latent feature quantities in a vector space;
searching for search target data to which the embedded vector similar to the embedded vector of the target data is associated, as candidate data, by using a search index associating the search target data with the embedded vector of the search target data;
applying a predetermined process to the candidate data to assign a rank to be combined with the target data for each of the candidate data; and
outputting a result obtained by combining the target data and the candidate data, based on the assigned rank.

According to the present disclosure, it is possible to combine two tables without requiring a high calculation cost even for large-scale data.

### BRIEF DESCRIPTION OF THE DRAWINGS

FIG. 1 is a block diagram showing a configuration of an information processing device according to a first example embodiment.

FIG. 2 is a diagram showing an outline of a process of converting a query column to an embedded vector.

FIG. 3 is a diagram showing an outline of a process of searching for neighborhood vectors using a search index.

FIG. 4 is a diagram showing an outline of a process performed to acquire a ranking result.

FIG. 5 is a flow diagram showing a flow of information processing according to the first example embodiment.

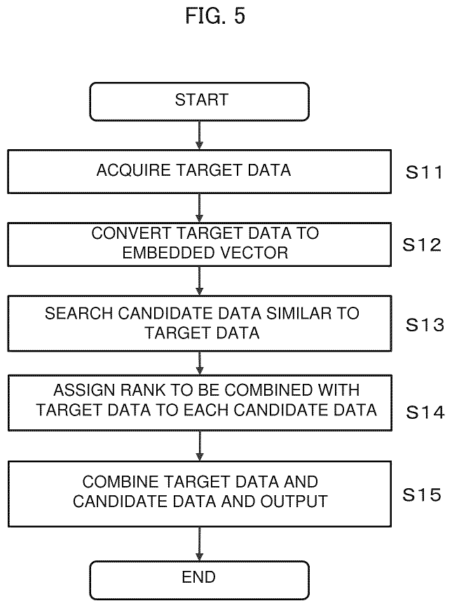

FIG. 6 is a block diagram showing a configuration of a computer functioning as an information processing device according to the first example embodiment.

FIG. 7 is a block diagram showing a configuration of an example to which the information processing device is applied.

FIG. 8 is a block diagram showing a configuration of another information processing device used for the construction of the information processing device according to the first example embodiment.

FIG. 9 is a diagram showing an outline of training an embedding model.

FIG. 10 is a diagram showing an outline of a process of converting an index-target column to an embedded vector.

FIG. 11 is a diagram showing an outline of a process of constructing a search index.

FIG. 12 is a diagram showing an outline of training a ranking model.

FIG. 13 is a flow diagram illustrating a flow of processing in another information processing device used for the construction of the information processing device according to the first example embodiment.

FIG. 14 is a block diagram showing a configuration of an information processing device according to a second example embodiment.

FIG. 15 is a flowchart for explaining processing performed in the information processing device according to the second example embodiment.

FIG. 16 is a block diagram showing a configuration of an information processing device according to a third example embodiment.

FIG. 17 is a flowchart for explaining processing performed in the information processing device according to a third example embodiment.

### EXAMPLE EMBODIMENTS

The example embodiment of the present disclosure will now be described in detail with reference to the attached drawings.

<Configuration of an Information Processing Device>

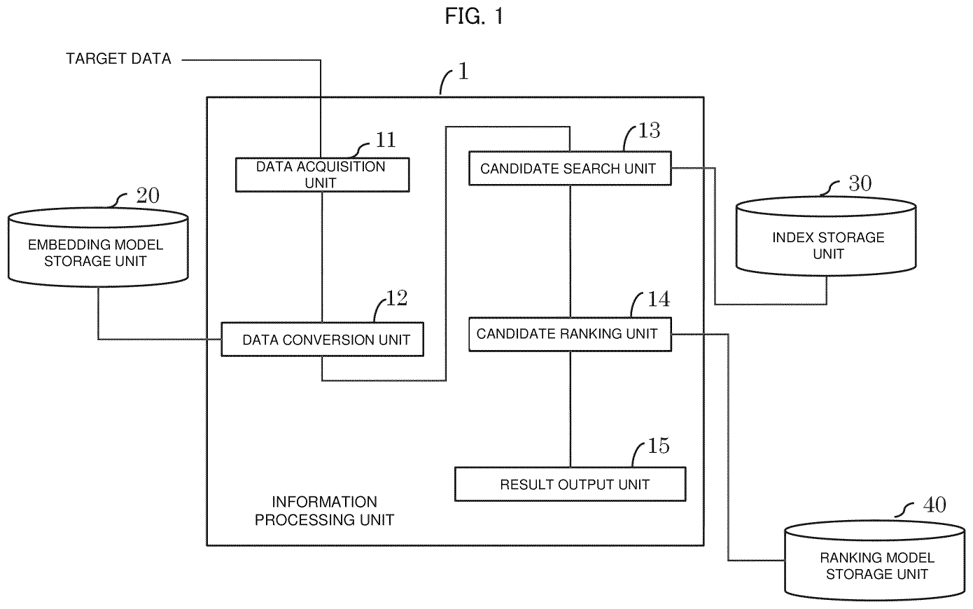

First, a configuration of an information processing device 1 according to the present example embodiment will be described with reference to FIG. 1. FIG. 1 is a block diagram illustrating a configuration of the information processing device 1. The information processing device 1 is a data search device for integrating data or a search device for searching for data, for example. The information processing device 1 includes a data acquisition unit 11, a data conversion unit 12, a candidate search unit 13, a candidate ranking unit 14, and a result output unit 15.

In the present example embodiment, the data acquisition unit 11 is configured to realize a data acquisition means, the data conversion unit 12 is configured to realize a data conversion means. Further, the candidate search unit 13 is configured to realize a candidate search means, the candidate ranking unit 14 is configured to realize a candidate ranking means, and the result output unit 15 is configured to realize a result output means.

The data acquisition unit 11 acquires target data. Here, the target data is data to which a predetermined process is applied. For example, the target data is a database including one or a plurality of records. However, the target data is not limited to the above-described example, and may be other data. The target data includes one or more attributes. The attribute included in the target data indicates the characteristic of the target data or the characteristic of the data included in the target data. For example, the attribute is a field included in the database that is the target data. However, the attribute included in the target data is not limited to the above-described example, and may be other attribute. The data acquisition unit 11 outputs the acquired target data to the data conversion unit 12.

The data conversion unit 12 applies a predetermined process to the target data to convert the target data to an embedded vector. Here, the predetermined process is the process applied to the target data. For example, the predetermined process is to convert the records included in the database serving as the target data to an embedded vector indicating the latent feature quantity of the target data by using the embedding model stored in the embedding model storage unit 20. The embedding model is a model that expresses arbitrary data in a vector space, in which the similarity between the data is expressed as a distance in the space. For example, the data conversion unit 12 acquires the feature quantity from the target data. Then, the data conversion unit 12 computes the vector value of the target data using the acquired feature quantity and the embedding model, and outputs the vector value to the candidate search unit 13.

As the feature quantity of the target data, the data conversion unit 12 may use the feature quantity calculated by the language model by using the values of the column of the target data as character strings. Alternatively, as the feature quantity of the target data, the data conversion unit 12 may use a statistic such as the number of words and characters. The method for learning the embedding model and the method for acquiring the feature quantity are not limited to specific ones, and a technique of general machine learning may be utilized. For example, the data conversion unit 12 may use a model trained by a training algorithm using a multilayer neural network, as the embedding model.

The candidate search unit 13 searches for candidate data which is similar to the embedded vector of the target data and which is to be combined with the target data. For example, the candidate search unit 13 acquires the data whose distance from (degree of similarity with) the embedded vector of the target data on the vector space satisfies a predetermined condition, as the candidate data. More specifically, the candidate search unit 13 performs the neighborhood search using the search index, stored in the index storage unit 30, that associates the candidate data and its embedded vector, and acquires the data having a small distance from the embedded vector of the target data as the candidate data. Then, the candidate search unit 13 outputs the acquired candidate data to the candidate ranking unit 14.

The number of candidate data acquired by the candidate search unit 13 is not particularly limited. For example, the candidate search unit 13 may use a predetermined value (K) determined in advance as the number of the candidate data.

The candidate ranking unit 14 performs ranking of the candidate data to be combined with the target data by applying a predetermined process to the candidate data. Here, the predetermined process is a process applied to the candidate data. For example, the candidate ranking unit 14 uses the target data, the candidate data, and the ranking model stored in the ranking model storage unit 40 to assign the priority to be combined with the target data to each candidate data. Then, the candidate ranking unit 14 outputs, to the result output unit 15, the ranking result indicating the priority to be combined with the target data.

The ranking model is a model for evaluating the easiness (combinability) of combining between the inputted target data and the candidate data. The ranking model is a model prepared in advance, and is stored in the ranking model storage unit 40. The algorithm for generating the ranking model is not particularly limited. The ranking model may be a model that evaluates the combinability using predetermined rules. Alternatively, the ranking model may be a model trained by a training algorithm utilizing a multilayer neural network.

The result output unit 15 combines the target data and the candidate data on the basis of the ranking result of the candidate data, and outputs it as the combined data.

The number of the candidate data combined by the result output unit 15 is not particularly limited. For example, the result output unit 15 may output the result of combining the top M candidate data with the target data using a predetermined value (M) determined in advance. Specifically, the result output unit 15 may include the 10 ×M (=K) candidate data in the ranking result, and may output the combined data indicating the result of combining the top M candidate data from among the 10 ×M (=K) candidate data with the target data, for example.

<Concrete Example of Configuration of Information Processing Device>

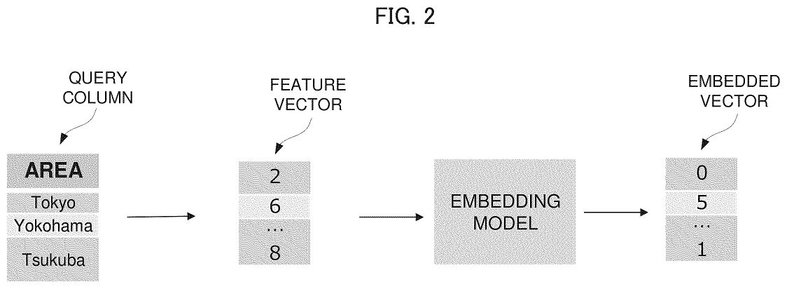

The data conversion unit 12 extracts the feature vector from the query column by using the same method as in the training of the embedding model, inputs the extracted feature vector to the embedding model, and outputs the vector calculated in the middle layer of the embedding model as the embedded vector. For example, when the query column including character strings such as “Tokyo”, “Yokohama” and “Tsukuba” is obtained as the target data as shown in FIG. 2, the data conversion unit 12 extracts the feature vector by digitizing the character strings and inputs the feature vector to the embedding model to convert the query column to the embedded vector. FIG. 2 is a diagram showing an outline of a process of converting a query column to an embedded vector.

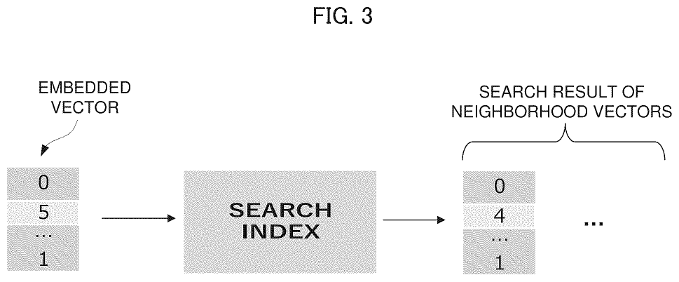

The candidate search unit 13 uses the search indexes to search for the neighborhood vectors corresponding to a set of the embedded vectors in the vicinity of the embedded vector outputted from the data conversion unit 12. The candidate search unit 13 acquires a set of the index-target columns associated with the searched neighborhood vectors as the candidate data, and outputs the acquired candidate data to the candidate ranking unit 14. For example, the candidate search unit 13 acquires the search result of the neighborhood vectors shown in FIG. 3 by performing the search using the search indexes. FIG. 3 is a diagram showing an outline of a process of searching the neighborhood vectors using the search indexes. According to such processing, the candidate search unit 13 can acquire K index-target columns corresponding to the K neighborhood vectors as the candidate data.

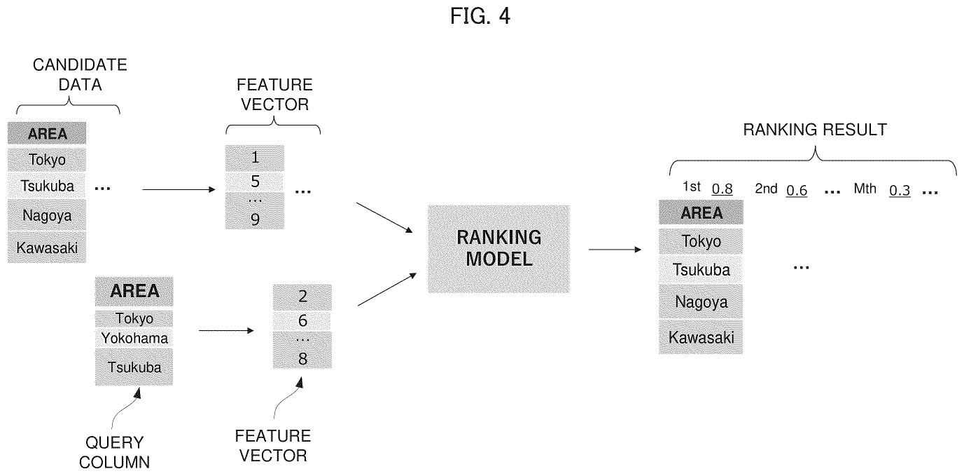

The candidate ranking unit 14 acquires the ranking result of assigning a relatively high rank to the index-target column similar to the query column, and assigning a relatively low rank to the index-target column not similar to the query column by using a ranking model. For example, as shown in FIG. 4, the candidate ranking unit 14 acquires the ranking results of the top M index-target columns from among the index-target columns by inputting the feature vector extracted from the query column including the character strings such as “Tokyo”, “Yokohama” and “Tsukuba” and the feature vectors extracted from the respective index-target columns included in the candidate data into the ranking model. In the example of FIG. 4, by inputting the feature vector extracted from the query column and the candidate data into the ranking model, the ranking result including the combining score indicating the inference result of the combinability (similarity) to the query column is obtained. Further, according to the example of FIG. 4, the first rank is assigned to the index-target column including the character strings “Tokyo”, “Tsukuba”, “Nagoya” and “Kawasaki”. Further, according to the example of FIG. 4, a value of 0.8 is obtained as the combining score of the index-target column including the character strings “Tokyo”, “Tsukuba”, “Nagoya” and “Kawasaki”. Further, according to the example of FIG. 4, it is possible to obtain the ranking result in which a relatively high rank is assigned to the index-target column having a relatively high combining score and a relatively low rank is assigned to the index-target column having a relatively low combining score. Note that the candidate ranking unit 14 may acquire a ranking result in which the combining scores are arranged in descending order, or may acquire a ranking result in which the combining scores are corrected by a predetermined method. FIG. 4 is a diagram showing an outline of process performed to acquire the ranking result.

<Information Processing>

Next, the flow of information processing according to the present example embodiment will be described with reference to FIG. 2. FIG. 2 is a flow diagram showing the flow of information processing.

First, the data acquisition unit 11 acquires the target data in step S11. In step S12, the data conversion unit 12 applies a predetermined process to the target data to convert the target data to the embedded vector, and outputs the embedded vector to the candidate search unit 13. In step S13, the candidate search unit 13 searches the candidate data, which are similar to the embedded vector of the target data and which are to be combined with the target data, in the index storage unit 30, and outputs the candidate data to the candidate ranking unit 14. In step S14, the candidate ranking unit 14 applies a predetermined process to a plurality of candidate data inputted from the candidate search unit 13 to perform ranking of the plurality of candidate data to be combined with the target data, and outputs the ranking result to the result output unit 15. In step S15, the result output unit 15 combines the target data and the candidate data based on the ranking result of the candidate data, and outputs the combined data.

<Example of Implementation by Software>

Some or all functions of the information processing device 1 may be implemented by hardware such as an integrated circuit (IC chip), or may be implemented by software.

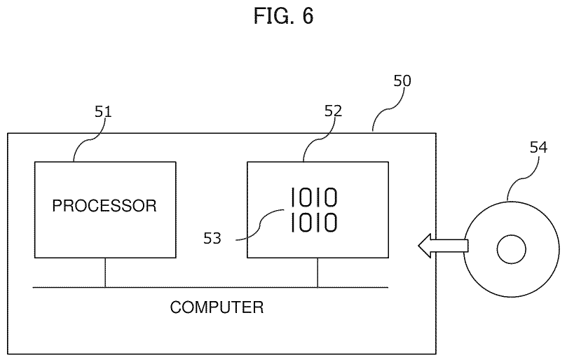

When the information processing device 1 is implemented by software, the information processing device 1 is realized, for example, by a computer that executes instructions of a program that is software realizing each function. FIG. 6 shows an example of such a computer. The computer 50 includes at least one processor 51 and at least one memory 52. In the memory 52, a program 53 for causing the computer 50 to operate as the information processing device 1 is recorded. In the computer 50, each function of the information processing device 1 is realized by the processor 51 which reads out and executes the program 53 from the memory 52.

As the processor 51, a CPU (Central Processing Unit), a GPU (Graphic Processing Unit), a DSP (Digital Signal Processor), a MPU (Micro Processing Unit), an FPU (Floating point number Processing Unit), a PPU (Physics Processing Unit), a microcontroller, or a combination thereof may be used. As the memory 52, a flash memory, a HDD (Hard Disk Drive), a SSD (Solid State Drive), or a combination thereof can be used, for example.

Incidentally, the computer 50 may also includes a RAM (Random Access Memory) for expanding the program 53 at runtime or temporarily storing various types of data. The computer 50 may also include a communication interface for transmitting and receiving data to and from other devices. The computer 50 may also include an input/output interface for connecting input/output devices such as a keyboard, mouse, display, or printer.

The program 53 may also be recorded on a tangible, non-transitory recording medium 54 that is readable by the computer 50. The recording medium 54 may be, for example, a tape, a disk, a card, a semiconductor memory, or a programmable logic circuit. The computer 50 can acquire the program 53 via such a recording medium 54. The program 53 can also be transmitted via a transmission medium. As such a transmission medium, for example, it is possible to use a communication network, or broadcast waves. The computer 50 may also acquire the program 53 via such a transmission medium.

### Effect of the Example Embodiment

As described above, in the present example embodiment, the information processing device 1 acquires the target data, converts the target data to an embedded vector by applying a predetermined process to the target data, and searches for the candidate data which are similar to the embedded vector of the target data and which are to be combined with the target data. In addition, in the present example embodiment, the information processing device 1 performs ranking of the searched candidate data using the ranking model, and combines the target data and the candidate data based on the rank. As described above, by using the similarity of the embedded vector and the ranking model, this example embodiment can combine two tables without requiring high computational cost even for large-scale data.

### EXAMPLE

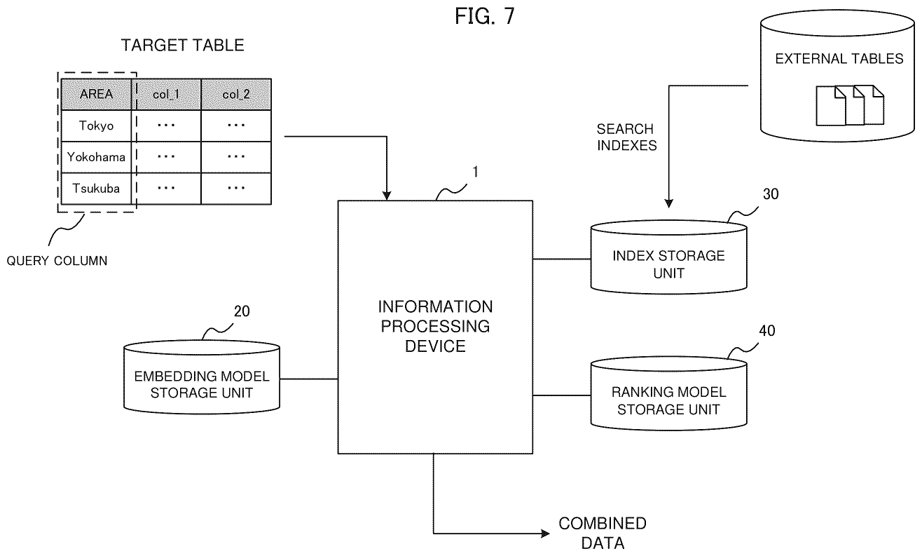

FIG. 7 shows a configuration of an example to which the information processing device according to the above-described example embodiment is applied. In this example, the information processing device searches for a table that can be combined with a target table from a large-scale external tables and combines it with the target table.

In FIG. 7, the information processing device 1 has the same configuration as the information processing device 1 shown in FIG. 1, and is connected to the embedding model storage unit 20, the index storage unit 30, and the ranking model storage unit 40. The target table is inputted to the information processing device 1 as the target data. In the this example, the information processing device 1 extracts the query column from the inputted target table and converts the query column to the embedded vector using a predetermined embedding model.

On the other hand, the search indexes are generated in advance from the external tables to be searched, and stored in the index storage unit 30. Specifically, in this example, the index-target columns are first selected from the external tables. The index-target columns correspond to the candidate data described above. The selected index-target columns are then converted to the embedded vectors. This conversion process is performed by the same model as the embedding model used to convert the query column extracted from the target table. Then, the search indexes associating the index-target columns with the embedded vectors are generated and stored in the index storage unit 30. In this way, the index storage unit 30 stores the search indexes for the external tables that can be combined with the target table.

The information processing device 1 acquires a plurality of index-target columns having a small distance from the embedded vector of the query column as the candidate data using the search indexes stored in the index storage unit 30. Next, the information processing device 1 performs ranking of the candidate data using the ranking model, and generates a ranking result indicating the priority to be combined with the target data for the plurality of candidate data. Then, based on the ranking result, the information processing device 1 combines the candidate data of top M priority with the target data, for example, and outputs the combined data.

According to the present example embodiment, it is possible to acquire a table that can be combined with the query column of the target table from the large-scale external tables and to combine it with the target table without requiring a high computation cost.

<Configuration for Constructing an Information Processing Device>

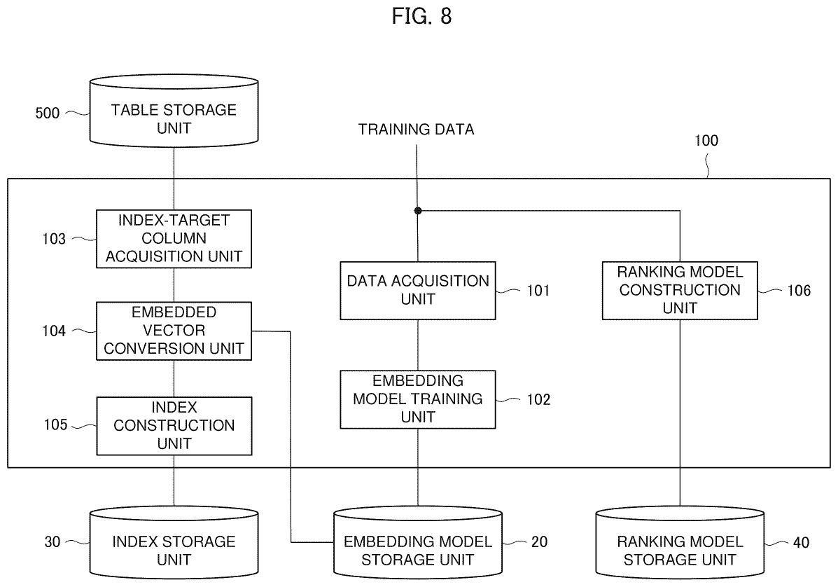

Next, the configuration of another information processing device used for constructing the information processing device 1 will be described. FIG. 8 is a block diagram illustrating a configuration of another information processing device used for constructing the information processing device according to the first example embodiment. The information processing device 100 is a device used for constructing the information processing device 1 and has a hardware configuration similar to the information processing device 1. As shown in FIG. 8, the information processing device 100 includes a data acquisition unit 101, an embedding model training unit 102, an index-target column acquisition unit 103, an embedded vector conversion unit 104, an index construction unit 105, and a ranking model construction unit 106.

The data acquisition unit 101 acquires training data and test data as training data of a machine learning model or a deep learning model.

The embedding model training unit 102 has an embedding model that is a model representing the distribution of the latent feature quantities in the vector space. Specifically, the embedding model is formed by a deep learning model such as a three-layer neural network, for example.

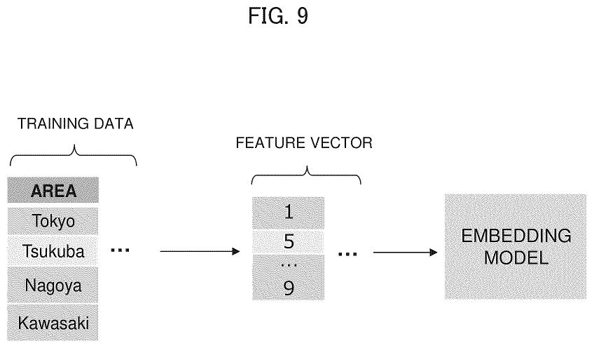

The embedding model training unit 102 extracts the feature vector from the values of the column of the training data acquired by the data acquisition unit 101, and trains the embedding model on the basis of the output result when the feature vector is inputted to the embedding model. For example, when the character strings such as “Tokyo,” “Tsukuba,” “Nagoya,” and “Kawasaki” are included in the column of the training data as shown in FIG. 9, the embedding model training unit 102 trains the embedding model by extracting the feature vector obtained by digitizing the character strings and inputting the extracted feature vector into the embedding model. Also, the embedding model training unit 102 extracts the feature vector from the values of the column of the test data acquired by the data acquisition unit 101, and adjusts the parameters of the embedding model based on the output result when the feature vector is inputted to the embedding model. FIG. 9 is a diagram showing an outline of training of the embedding model.

If the values of the column of the training data and the values of the column of the test data are both character strings, each feature quantity included in the feature vector used for training the embedding model may be calculated based on a predetermined language model, or may be calculated based on the count value of the number of words or characters. If both the values of the column of the training data and the values of the column of the test data are character strings, the feature vector used for training the embedding model can be obtained by performing the transformation process using word embedding.

The training of the embedding model may be performed on the basis of the relationship between the values of column that the feature vector is based on and the embedded vector that is outputted according to the input of the feature vector, for example. Alternatively, the training of the embedding model may be performed as a self-supervised learning using the output data outputted in response to the input of the feature vector, for example. In addition, the training of the embedding model may be repeated until the end condition is satisfied. For example, the end condition may be set to such a condition that, when a plurality of feature vectors extracted from the values of a plurality of columns similar to each other are inputted, a plurality of embedded vectors, for which the distance in the vector space is close to each other and whose dimensionality are smaller than the dimensionality of the inputted feature vectors, are outputted.

The embedding model training unit 102 stores the embedding model trained as described in the above specific examples in the embedding model storage unit 20. Therefore, the data conversion unit 12 can convert the target data into the embedded vector by inputting the feature vector extracted from the target data into the trained embedding model acquired from the embedding model storage unit 20. Further, the data conversion unit 12 can convert a plurality of target data similar to each other into a plurality of embedded vectors close to each other in the vector space by using the trained embedding model acquired from the embedding model storage unit 20.

The index-target column acquisition unit 103 acquires the index-target columns used for constructing the search indexes from the external tables stored in the table storage unit 500. The index-target columns may include at least one or more columns selected from one table belonging to the external tables. The index-target columns may include multiple columns selected from multiple tables belonging to the external tables. The index-target column acquisition unit 103 may selectively acquire the index-target column according to a predetermined rule or may selectively acquire the index-target column by the inference method of the machine learning. Specifically, the index-target column acquisition unit 103 may selectively acquire the column whose values are character strings and which has a largest number of unique values.

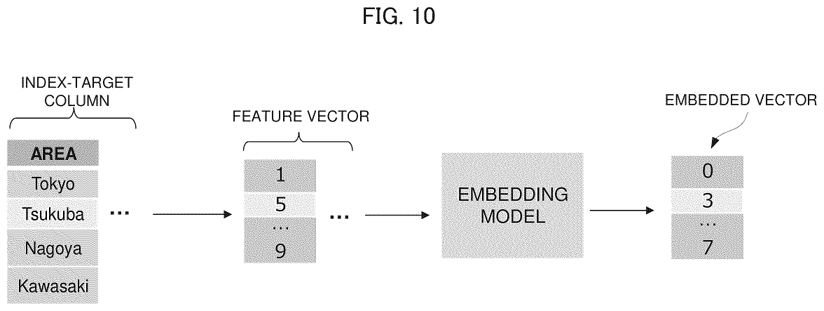

The embedded vector conversion unit 104 converts the index-target column acquired by the index-target column acquisition unit 103 to the embedded vector using the trained embedding model stored in the embedding model storage unit 20. For example, when the character strings such as “Tokyo”, “Tsukuba”, “Nagoya”, or “Kawasaki” are included in the index-target column as shown in FIG. 10, the embedded vector conversion unit 104 extracts a feature vector obtained by digitizing the character strings and inputs the extracted feature vector into the embedding model to convert the index-target column to the embedded vector. The method of extracting the feature vector from the index-target column may be the same as the method used to extract the feature vector from the training data (the training data and the test data) of the embedding model. FIG. 10 is a diagram showing an outline of a process of converting the index-target column to the embedded vector.

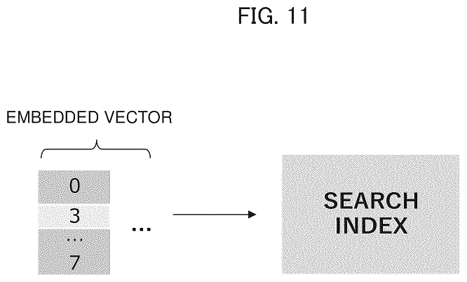

The index construction unit 105 constructs the search indexes by applying a predetermined algorithm to the set of embedded vectors obtained by transforming the set of index-target columns, as shown in FIG. 11. Specifically, the index construction unit 105 constructs the search indexes by applying an algorithm disclosed in https://github.com/spotify/annoy or an algorithm disclosed in https://github.com/facebookresearch/faiss to the set of embedded vectors obtained by transforming the index-target columns, for example. FIG. 11 is a diagram showing an outline of a process of constructing a search index.

The index construction unit 105 stores the search indexes constructed by the method described in the above specific example in the index storage unit 30.

According to the method described in the above-described specific example, the search indexes in which the index-target columns acquired by the index-target column acquisition unit 103 are associated with the embedded vectors of the index-target columns can be constructed. In addition, the candidate search unit 13 can search (acquire) the index-target column to which the embedded vector similar to the embedded vector of the target data is associated, as the candidate data, by using the search indexes constructed by the above-described method.

Further, according to the method described in the above specific example, it is possible to construct a search index including a representative vector associated with a plurality of embedded vectors whose distances in the vector space are close to each other. In such a case, for example, the candidate search unit 13 can search (acquire) the index-target column associated with each of the plurality of embedded vectors, as the candidate data, by searching for a representative vector similar to the embedded vector of the target data and identifying a plurality of embedded vectors associated with the representative vector.

The ranking model construction unit 106 has a ranking model configured by one of a model according to a predetermined rule, a machine learning model, or a deep learning model. This specific example is directed to the case where the ranking model is a machine learning model or a deep learning model, unless otherwise mentioned.

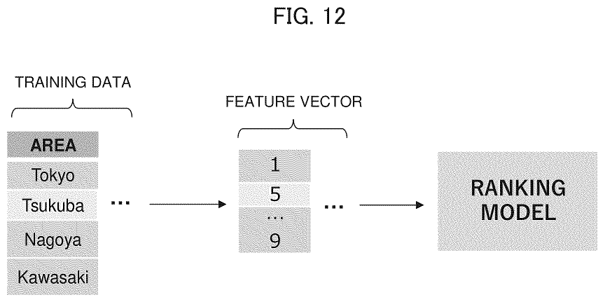

The ranking model construction unit 106 extracts the feature vector from the values of the column of the training data acquired by the data acquisition unit 101 and trains the ranking model on the basis of the output result when the feature vector is inputted to the ranking model. For example, when character strings such as “Tokyo”, “Tsukuba”, “Nagoya” and “Kawasaki” are included in the column of the training data as shown in FIG. 12, the ranking model construction unit 106 extracts a feature vector by digitizing the character strings and inputs the extracted feature vector into the ranking model to train the ranking model. Further, the ranking model construction unit 106 extracts the feature vector from the values of the column of the test data acquired by the data acquisition unit 101 and performs parameter adjustment of the ranking model on the basis of the output result when the feature vector is inputted to the ranking model. FIG. 12 is a diagram showing an outline of training the ranking model.

For example, when the values of the column of the training data and the values of the column of the test data are both character strings, each feature quantity included in the feature vector used for training the ranking model may be calculated based on a predetermined language model, or may be calculated based on the count value of the number of words or characters. For example, when both the values of the column of the training data and the values of the column of the test data column are character strings, the feature vector used for training the ranking model can be obtained by performing the transformation process using word embedding.

The ranking model construction unit 106 stores the ranking model constructed by the method described in the above specific example in the ranking model storage unit 40. Therefore, the candidate ranking unit 14 can obtain the ranking result by inputting the feature vectors extracted from the target data and the candidate data into the ranking model acquired from the ranking model storage unit 40. Further, the candidate ranking unit 14 can obtain the ranking result in which a relatively high rank is assigned to the candidate data similar to the target data and a relatively low rank is assigned to the candidate data not similar to the target data.

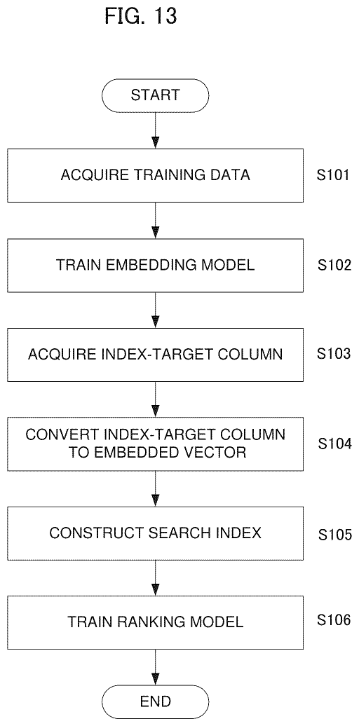

Next, a flow of processing of the information processing device 100 described above will be described. FIG. 13 is a flow diagram illustrating a flow of processing in another information processing device used for constructing the information processing device according to the first example embodiment.

First, in step S101, the data acquisition unit 101 acquires the training data of the machine learning model or the deep learning model. Next, in step S102, the embedding model training unit 102 trains the embedding model using the training data obtained in step S101 and then stores the trained embedding model in the embedding model storage unit 20. Subsequently, in step S103, the index-target column acquisition unit 103 acquires the index-target columns from the external tables stored in the table storage unit 500. Subsequently, in step S104, the embedded vector conversion unit 104 converts the index-target columns obtained in step S103 into embedded vectors. Subsequently, in step S105, the index construction unit 105 constructs the search indexes by applying a predetermined algorithm to the embedded vectors obtained in step S104, and stores the constructed search indexes in the index storage unit 30. Finally, in step S106, the ranking model construction unit 106 trains the ranking model using the training data obtained in step S101, and then stores the trained ranking model in the ranking model storage unit 40.

### Second Example Embodiment

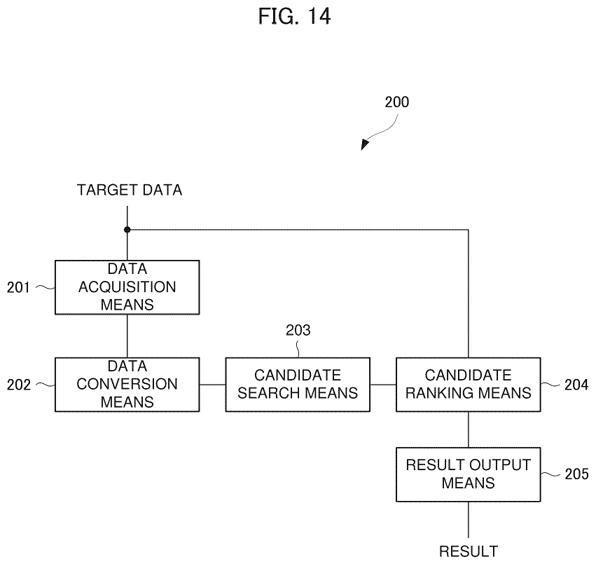

FIG. 14 is a block diagram illustrating a configuration of an information processing device according to a second example embodiment.

The information processing device 200 according to this example embodiment has the same hardware configuration as that of the information processing device 1. The information processing device 200 includes a data acquisition means 201, a data conversion means 202, a candidate search means 203, a candidate ranking means 204, and a result output means 205.

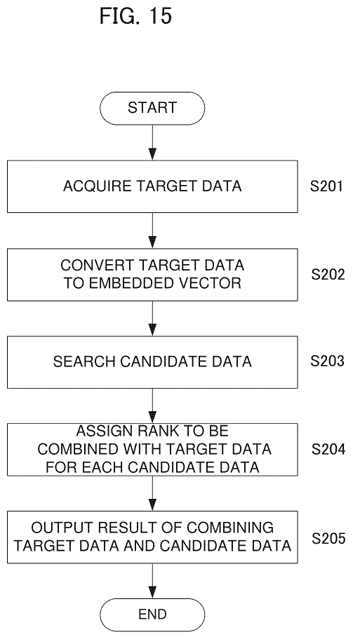

FIG. 15 is a flowchart for explaining the processing performed in the information processing device according to the second example embodiment.

The data acquisition means 201 acquires target data (step S201).

The data conversion means 202 converts the target data to an embedded vector indicating a latent feature quantity of the target data (step S202).

The candidate search means 203 searches for data similar to the latent feature quantity of the target data as candidate data (step S203).

The candidate ranking means 204 applies a predetermined process to the candidate data and assigns a rank to be combined with the target data for each of the candidate data (step S204).

The result output means 205 outputs a result of combining the target data and the candidate data based on the assigned rank (step S205).

According to this example embodiment, two tables can be combined without requiring high computational cost even for large-scale data.

### Third Example Embodiment

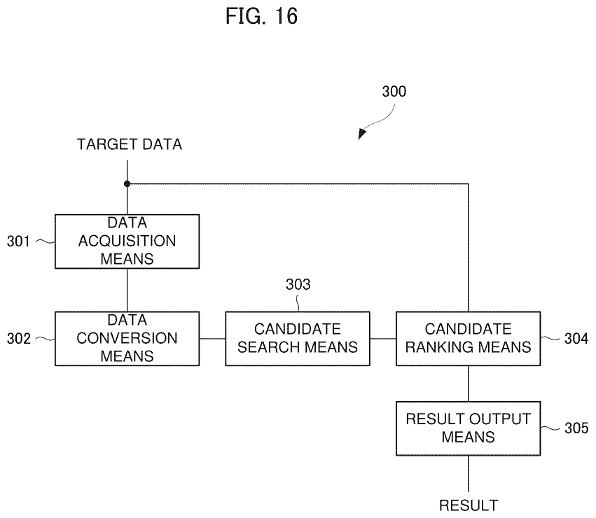

FIG. 16 is a block diagram illustrating a configuration of an information processing device according to a third example embodiment.

The information processing device 300 according to the present example embodiment has the same hardware configuration as the information processing device 100. The information processing device 300 includes a data acquisition means 301, a data conversion means 302, a candidate search means 303, a candidate ranking means 304, and a result output means 305.

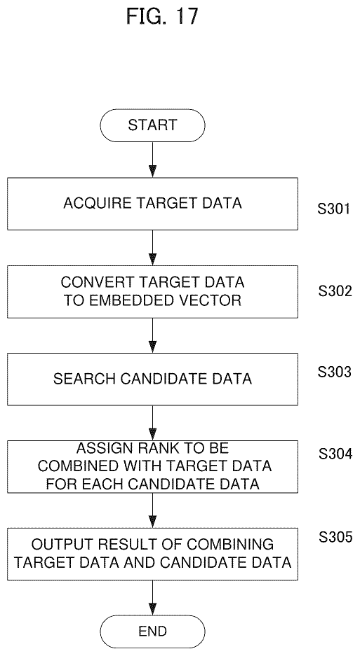

FIG. 17 is a flowchart for explaining a process performed in the information processing device according to the third example embodiment.

The data acquisition means 301 acquires target data (step S301).

The data conversion means 302 converts the target data to an embedded vector by inputting a feature vector extracted from the target data into an embedding model which is a model representing a distribution of latent feature quantities in a vector space (step S302).

The candidate search means 303 searches for search target data to which the embedded vector similar to the embedded vector of the target data is associated, as candidate data, by using a search index associating the search target data with the embedded vector of the target data (step S303).

The candidate ranking means 304 applies a predetermined process to the candidate data and assigns a rank to be combined with the target data for each of the candidate data (step S304).

The result output means 305 outputs a result of combining the target data and the candidate data based on the assigned rank (step S305).

According to this example embodiment, two tables can be combined without requiring high computational cost even for large-scale data.

Some or all of the above example embodiments may also be described as in the following supplementary notes, but are not limited to:

(Supplementary Note 1)

An information processing device comprising:
a data acquisition means configured to acquire target data;
a data conversion means configured to convert the target data to an embedded vector indicating a latent feature quantity of the target data;
a candidate search means configured to search for data similar to the latent feature quantity of the target data as candidate data;
a candidate ranking means configured to apply a predetermined process to the candidate data to assign a rank to be combined with the target data, for each of the candidate data; and
a result output means configured to output a result obtained by combining the target data and the candidate data based on the assigned rank.

(Supplementary Note 2)

The information processing device according to Supplementary note 1, wherein the candidate search means searches for the candidate data by performing a neighborhood search based on the embedded vector of the target data.

(Supplementary Note 3)

The information processing device according to Supplementary note 1, wherein the embedded vector is acquired by a deep learning model trained using a multilayer neural network.

(Supplementary Note 4)

An information processing method comprising:
acquiring target data;
converting the target data to an embedded vector indicating a latent feature quantity of the target data;
searching for data similar to the latent feature quantity of the target data as candidate data;
applying a predetermined process to the candidate data to assign a rank to be combined with the target data, for each of the candidate data; and
outputting a result obtained by combining the target data and the candidate data based on the assigned rank.

(Supplementary Note 5)

A recording medium recording a program, the program causing a computer to execute processing of:
acquiring target data;
converting the target data to an embedded vector indicating a latent feature quantity of the target data;
searching for data similar to the latent feature quantity of the target data as candidate data;
applying a predetermined process to the candidate data to assign a rank to combine with the target data, for each of the candidate data; and
outputting a result obtained by combining the target data and the candidate data based on the assigned rank.

(Supplementary Note 6)

An information processing device comprising:
a data acquisition means configured to acquire target data;
a data conversion means configured to convert the target data to an embedded vector by inputting a feature vector extracted from the target data into an embedding model, the embedding model representing a distribution of latent feature quantities in a vector space;
a candidate search means configured to search for search target data to which the embedded vector similar to the embedded vector of the target data is associated, as candidate data, by using a search index associating the search target data with the embedded vector of the search target data;
a candidate ranking means configured to apply a predetermined process to the candidate data to assign a rank to be combined with the target data, for each of the candidate data; and
a result output means configured to output a result obtained by combining the target data and the candidate data, based on the assigned rank.

(Supplementary Note 7)

The information processing device according to Supplementary note 6, wherein the embedding model is trained such that, when a plurality of feature vectors extracted from a plurality of data similar to each other are inputted, the embedding model outputs a plurality of embedded vectors whose distances in the vector space are close to each other and whose dimensionality are smaller than dimensionalities of the inputted feature vectors.

(Supplementary Note 8)

The information processing device according to Supplementary note 7, wherein the embedded vector of the search target data included in the search index is converted by inputting the feature vector extracted from the search target data into the trained embedding model.

(Supplementary Note 9)

An information processing method comprising:
acquiring target data;
converting the target data to an embedded vector by inputting a feature vector extracted from the target data into an embedding model, the embedding model representing a distribution of latent feature quantities in a vector space;
searching for search target data to which the embedded vector similar to the embedded vector of the target data is associated, as candidate data, by using a search index associating the search target data with the embedded vector of the search target data;
applying a predetermined process to the candidate data to assign a rank to be combined with the target data, for each of the candidate data; and
outputting a result obtained by combining the target data and the candidate data, based on the assigned rank.

(Supplementary Note 10)

A recording medium recording a program, the program causing a computer to execute processing of:
acquiring target data;
converting the target data to an embedded vector by inputting a feature vector extracted from the target data into an embedding model, the embedding model representing a distribution of latent feature quantities in a vector space;
searching for search target data to which the embedded vector similar to the embedded vector of the target data is associated, as candidate data, by using a search index associating the search target data with the embedded vector of the search target data;
applying a predetermined process to the candidate data to assign a rank to be combined with the target data for each of the candidate data; and
outputting a result obtained by combining the target data and the candidate data, based on the assigned rank.

While the present invention has been described with reference to the example embodiments, the present invention is not limited to the above example embodiments. Various modifications that can be understood by a person skilled in the art within the scope of the present invention can be made to the configuration and details of the present invention. That is, the present invention includes, of course, various modifications and modifications that may be made by a person skilled in the art according to the entire disclosure and technical concepts including the scope of claims. In addition, each disclosure of the above-mentioned patent documents cited shall be incorporated by reference in this document.

This application is based upon and claims the benefit of priority from Japanese Patent Applications No. 2022-113698 filed on Jul. 15, 2022 and No. 2022-143435 filed on Sep. 9, 2022, the disclosure of which are incorporated herein in its entirety by reference.

### DESCRIPTION OF SYMBOLS

1 Information processing device
11 Data acquisition unit
12 Data conversion unit
13 Candidate search unit
14 Candidate ranking unit
15 Result output unit
20 Embedding model storage unit
30 Index storage unit
40 Ranking model storage unit
50 Computer

1. An information processing device comprising:
a memory configured to store instructions; and
one or more processors configured to execute the instructions to:
acquire target data;
convert the target data to an embedded vector indicating a latent feature quantity of the target data;
search for data similar to the latent feature quantity of the target data as candidate data;
apply a predetermined process to the candidate data to assign a rank to be combined with the target data, for each of the candidate data; and
output a result obtained by combining the target data and the candidate data based on the assigned rank.

2. The information processing device according to claim 1, wherein the one or more processors search for the candidate data by performing a neighborhood search based on the embedded vector of the target data.

3. The information processing device according to claim 1, wherein the embedded vector is acquired by a deep learning model trained using a multilayer neural network.

4. An information processing method comprising:
acquiring target data;
converting the target data to an embedded vector indicating a latent feature quantity of the target data;
searching for data similar to the latent feature quantity of the target data as candidate data;
applying a predetermined process to the candidate data to assign a rank to be combined with the target data, for each of the candidate data; and
outputting a result obtained by combining the target data and the candidate data based on the assigned rank.

5. A program causing a computer to execute the information processing method according to claim 4.

6. An information processing device comprising:
a memory configured to store instructions; and
one or more processors configured to execute the instructions to:
acquire target data;
convert the target data to an embedded vector by inputting a feature vector extracted from the target data into an embedding model, the embedding model representing a distribution of latent feature quantities in a vector space;
search for search target data to which the embedded vector similar to the embedded vector of the target data is associated, as candidate data, by using a search index associating the search target data with the embedded vector of the search target data;
apply a predetermined process to the candidate data to assign a rank to be combined with the target data, for each of the candidate data; and
output a result obtained by combining the target data and the candidate data, based on the assigned rank.

7. The information processing device according to claim 6, wherein the embedding model is trained such that, when a plurality of feature vectors extracted from a plurality of data similar to each other are inputted, the embedding model outputs a plurality of embedded vectors whose distances in the vector space are close to each other and whose dimensionality are smaller than dimensionalities of the inputted feature vectors.

8. The information processing device according to claim 7, wherein the embedded vector of the search target data included in the search index is converted by inputting the feature vector extracted from the search target data into the trained embedding model.
